(19) United States
(12) Patent Application Publication
(10) Pub. No.: US 2012/0220214 A1
(43) Pub. Date: Aug. 30, 2012

(54) METHOD AND APPARATUS FOR PROVISION OF PAGING MESSAGES IN RELAY NETWORK

(75) Inventors: Lei Du, Beijing (CN); Min Huang, Beijing (CN); Yong Teng, Beijing (CN)

(73) Assignee: NOKIA SIEMENS NETWORKS OY, Espoo (FI)

(21) Appl. No.: 13/502,568

(22) PCT Filed: Oct. 19, 2009
(86) PCT No.: PCT/CN2009/074519

§ 371 Date: Apr. 18, 2012

(51) Int. Cl. H04W 48/16; H04W 88/04

(52) U.S. Cl. 455/7; 455/515

(57) ABSTRACT

Provided are a method and apparatus for the provision of paging messages in a wireless network which includes relays. The method comprises that a base station receives a paging message and transmits the paging message to at least one relay node with or without processing, and the at least one relay node transmits the paging message to a user equipment with or without modification.

The present invention relates to a method and apparatus,

A communication system can be seen as a facility that enables communication sessions between two or more entities such as mobile communication devices and/or other stations associated with the communication system. A communication system and a compatible communication device typically operate in accordance with a given standard or specification which sets out what the various entities associated with the system are permitted to do and how that should be achieved. For example, the standard or specification may define if a communication device is provided with a circuit switched carrier service or a packet switched carrier service or both. Communication protocols and/or parameters which shall be used for the connection are also typically defined. For example, the manner how the communication device can access the communication system and how communication shall be implemented between communicating devices, the elements of the communication network and/or other communication devices is typically based on predefined communication protocols.

In a wireless communication system at least a part of the communication between at least two stations occurs over a wireless link. Examples of wireless systems include public land mobile networks (PLMN), satellite based communication systems and different wireless local networks, for example wireless local area networks (WLAN). The wireless systems can be divided into cells, and are therefore often referred to as cellular systems.

A user can access the communication system by means of an appropriate communication device. A communication device of a user is often referred to as user equipment (UE). A communication device is provided with an appropriate signal receiving and transmitting arrangement for enabling communications with other parties. Typically a communication device is used for enabling the users thereof to receive and transmit communications such as speech and data. In wireless systems a communication device provides a transceiver station that can communicate with e.g. a base station of an access network servicing at least one cell and/or another communications device. Depending on the context, a communication device or user equipment may also be considered as being a part of a communication system. In certain applications, for example in ad-hoc networks, the communication system can be based on use of a plurality of user equipment capable of communicating with each other.

The communication may comprise, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. The user may also be provided broadcast or multicast content. Non-limiting examples of the content include downloads, television and radio programs, videos, advertisements, various alerts and other information.

3^{rd} Generation Partnership Project (3GPP) is standardizing an architecture that is known as the long-term evolution (LTE) of the Universal Mobile Telecommunications System (UMTS) radio-access technology. The aim is to achieve, inter alia, reduced latency, higher user data rates, improved system capacity and coverage, and reduced cost for the operator. A further development of the LTE is referred to herein as LTE-Advanced. The LTE-Advanced aims to provide further enhanced services by means of even higher data rates and lower latency with reduced cost. The various development stages of the 3GPP LTE specifications are referred to as releases.

Since the new spectrum bands for international mobile telecommunications (IMT) contain higher frequency bands and LTE-Advanced is aiming at a higher data rate, coverage of one Node B (base station) may be limited due to the high propagation loss and limited energy per bit. Relaying has been proposed as a possibility to enlarge the coverage. Introducing relay concepts may help in the provision of high-bit-rate coverage in a high shadowing environment, reducing average radio-transmission power at the User Equipment (UE). This may lead to long battery life, enhanced cell capacity and effective throughput, e.g., increasing cell-edge capacity, balancing cell load, enhancing overall performance, and reducing deployment costs of radio access networks (RAN). The relaying would be provided by entities referred to as Relay stations (RSs) or Relay Nodes (RNs). The relay nodes can be fixed or mobile, for example mounted to a high-speed train. In some systems the relay stations may be opportunistically available user equipment/mobile terminals that are not owned by the network itself.

Paging is a procedure which is used to page user equipment in an idle mode, inform the user equipment about a change in system information, provide an ETWS (Earthquake and Tsunami Warning System) notification or the like. The paging procedure may be initiated by a network entity sending a paging message to a base station. That base station will then send a paging message to the user equipment.

To date, no consideration has been given to the provision of paging messages in a network which includes relays.

### STATEMENT OF INVENTION

According to an aspect of the present invention, there is provided a node comprising means for receiving a paging message; and transmitting means for transmitting the paging message to at least one relay node.

According to another aspect of the present invention, there is provided an apparatus for use in a base station comprising processing means for modifying a received paging message; and means for causing transmission of the modified paging message to a relay node.

According to a further aspect of the present invention, there is provided an apparatus for use in a base station comprising processing means for processing a received paging message to generate at least one user equipment paging message in a format suitable for transmission to a user equipment; and means for causing transmission of said at least one user equipment paging message to a relay node.

According to a fourth aspect of the present invention, there is provided an apparatus for use in a relay node comprising means for processing a received paging message to provide a modified paging message; and means for causing transmission of the modified paging message to the user equipment.

According to a fifth aspect of the present invention, there is provided a relay node comprising receiving means for receiving at least one paging message, said at least one paging message for transmission to a user equipment; and means for transmitting said at least one paging message without modification to respective user equipment.

According to a sixth aspect of the present invention, there is provided a method comprising receiving a paging message; and transmitting the paging message to at least one relay node.

According to a seventh aspect of the present invention, there is provided a method comprising modifying a received paging message; and causing transmission of the modified paging message to a relay node.

According to an eighth aspect of the present invention, there is provided a method comprising processing a received paging message to generate at least one user equipment paging message for transmission to a user equipment; and causing transmission of said at least one user equipment paging message to a relay node.

According to a ninth aspect of the present invention, there is provided a method comprising processing a received paging message to provide a modified paging message; and causing transmission of the modified paging message to the user equipment.

According to a tenth aspect of the present invention, there is provided a method comprising receiving means for receiving at least one paging message, said at least one paging message in a format suitable for transmission to a user equipment; and means for transmitting said at least one paging message without modification to respective user equipment.

According to an eleventh aspect of the present invention, there is provided an apparatus comprising at least one processor and at least one memory including program code, the at least one memory and the program code configured to, with the at least one processor cause the apparatus at least to: receive a paging message; and transmit the paging message to at least one relay node.

According to a twelfth aspect of the present invention, there is provided an apparatus comprising at least one processor and at least one memory including program code, the at least one memory and the program code configured to, with the at least one processor cause the apparatus at least to modify a received paging message; and cause transmission of a modified paging message to a relay node.

According to a thirteenth aspect of the present invention, there is provided an apparatus comprising at least one processor and at least one memory including program code, the at least one memory and the program code configured to, with the at least one processor cause the apparatus at least to process a received paging message to generate at least one user equipment paging message in a format suitable for transmission to a user equipment; and cause transmission of said at least one user equipment paging message to a relay node.

According to a fourteenth aspect of the present invention, there is provided an apparatus comprising at least one processor and at least one memory including program code, the at least one memory and the program code configured to, with the at least one processor cause the apparatus at least to process a received paging message to provide a modified paging message; and cause transmission of the modified paging message to the user equipment.

For a better understanding of the present invention and as to how the same may be carried into effect, reference will now be made by way of example only to the following drawings in which:

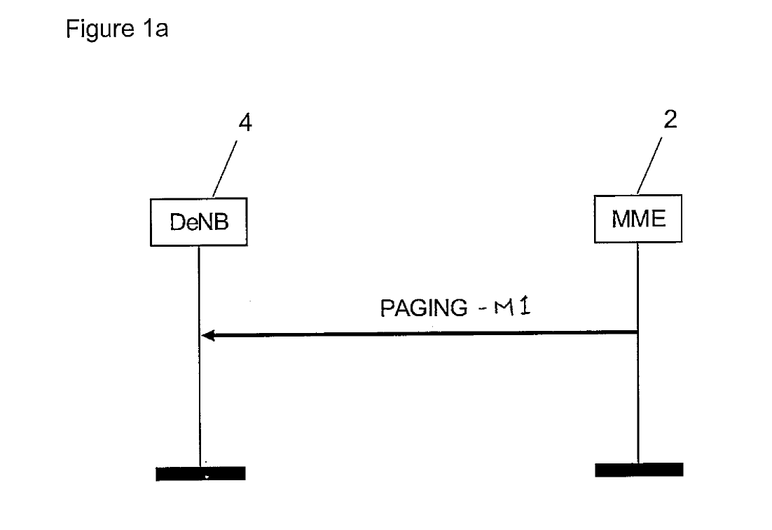

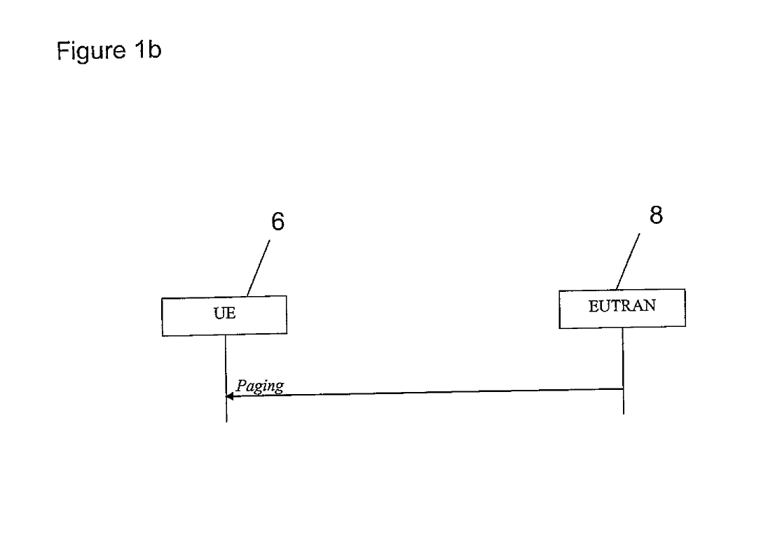

FIG. 1a shows a paging message being sent from a network entity to a base station;

FIG. 1b illustrates the sending of a paging message from a radio access node to a user equipment;

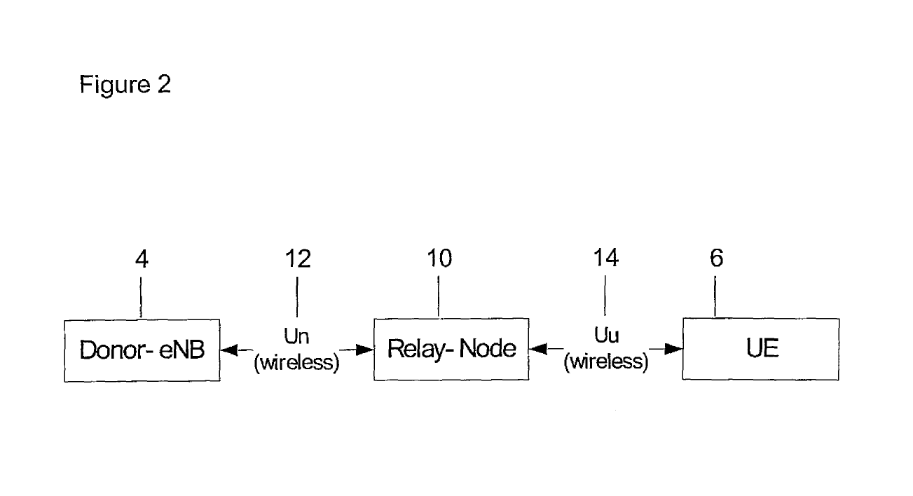

FIG. 2 shows schematically the interfaces between a base station, relay node and user equipment;

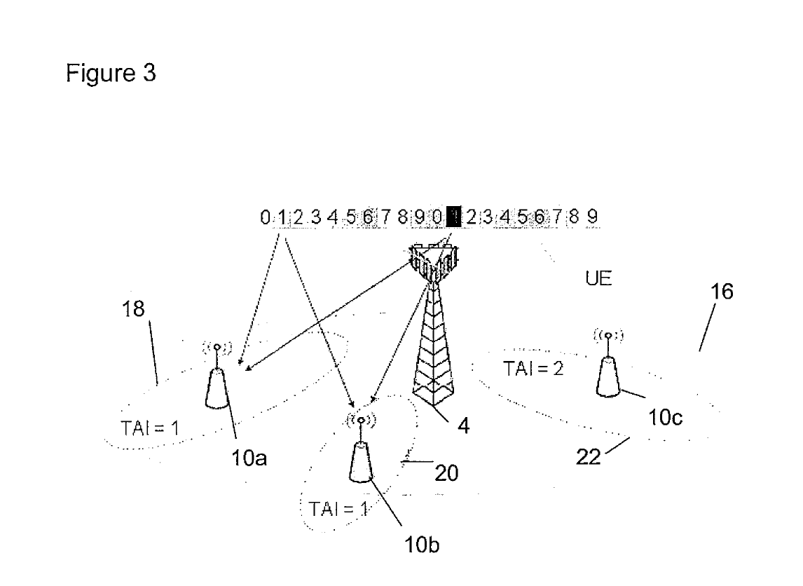

FIG. 3 shows a cell served by a base station and three relay nodes;

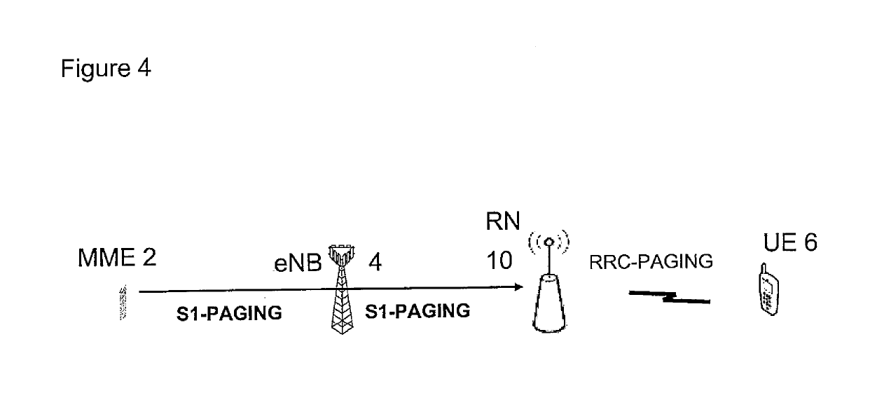

FIG. 4 shows a first paging message method embodying the present invention;

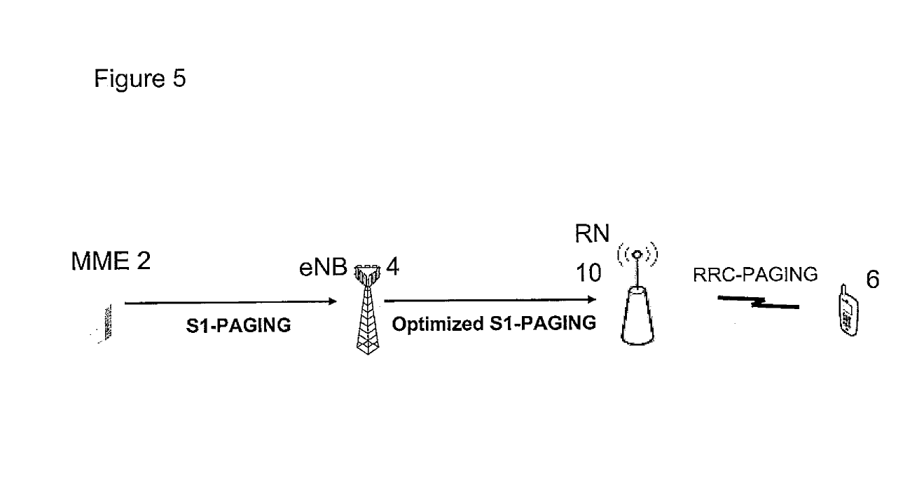

FIG. 5 shows a second paging message method embodying the present invention;

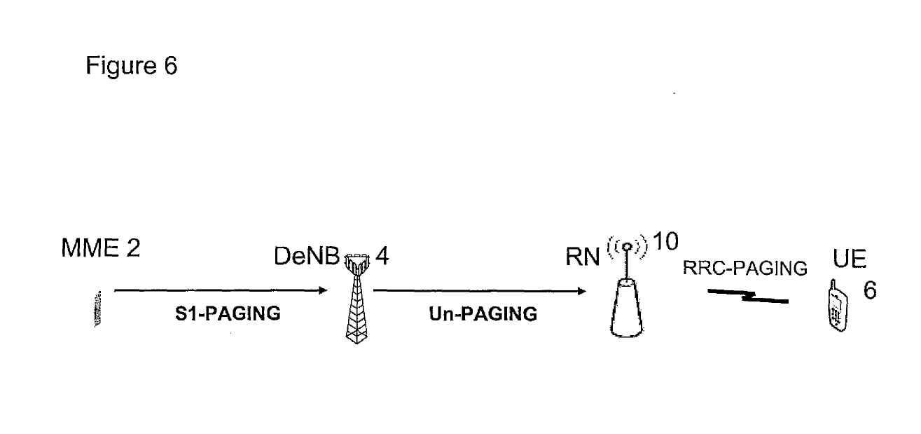

FIG. 6 shows a third paging message method embodying the present invention;

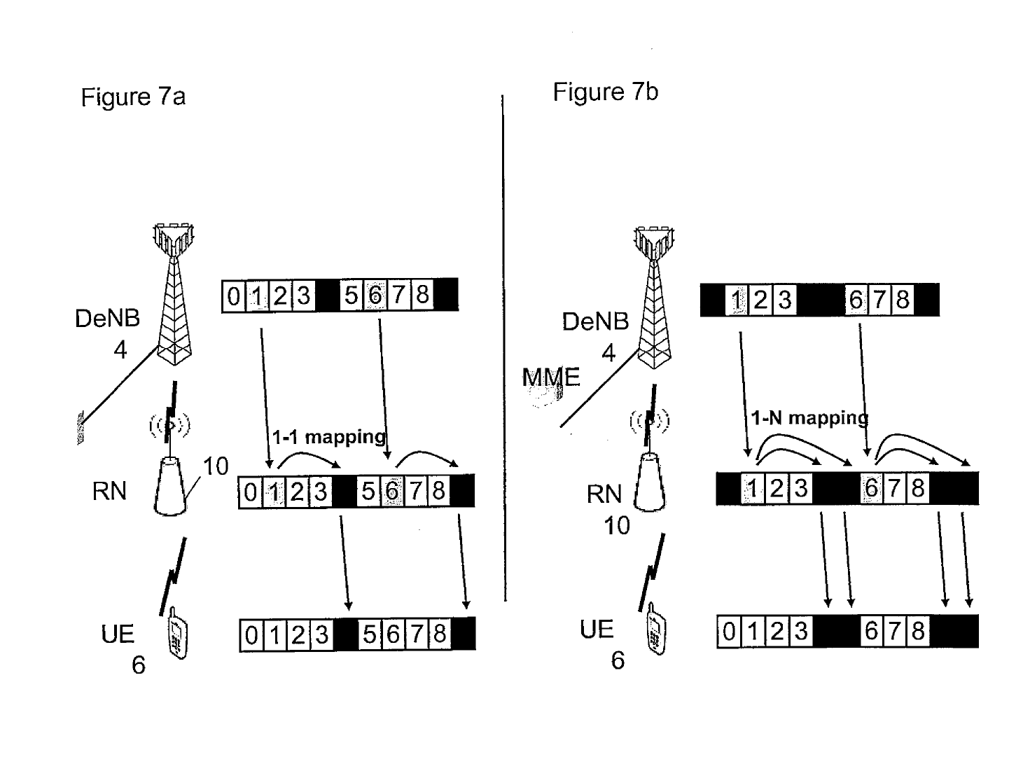

FIG. 7a shows one-to-one mapping of paging occasions where one paging occasion on the interface between the base station and the relay node is mapped to one paging occasion in the interface between the relay node and the user equipment;

FIG. 7b shows a one-to-N mapping where one paging occasion of the interface between the base station and the relay node is mapped to N paging occasions between the relay node and user equipment; and

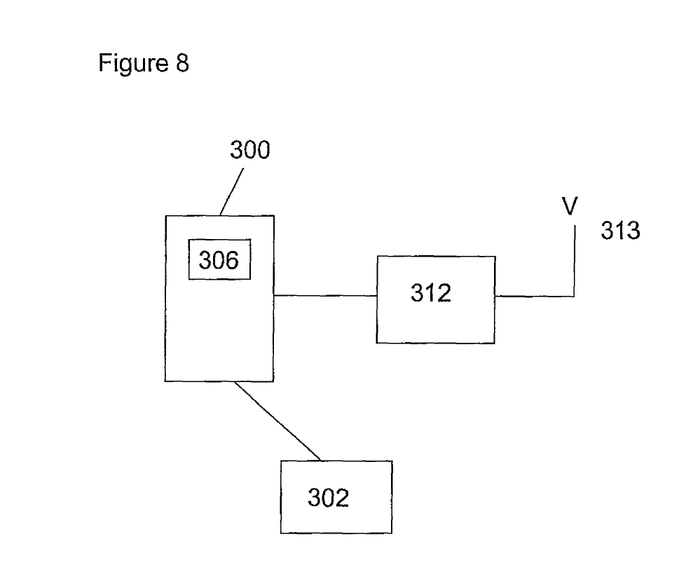

FIG. 8 shows a block diagram of a node embodying the invention.

As specified in 3GPP TR36.814 (3^{rd} Generation Partnership Project) relaying is considered as one of the potential techniques for LTE-A (Advanced Long Term Evolution) of 3GPP where a relay node RN is wirelessly connected to the radio access network via a donor cell. Some embodiments of the present invention are described in the context of the LTE-A proposal. However, other embodiments of the present invention can be used in any other scenario which, for example requires or uses one or more relays.

Reference is made to FIG. 3 which shows part of an LTE radio access network (RAN). An access node 4 is provided. The access node can be a base station of a cellular system, a base station of a wireless local area network (WLAN) and/or WiMax (Worldwide Interoperability for Microwave Access). In certain systems the base station is referred to as a node B or enhanced node B (e-NB). For example, in LTE-A, the base station is referred to as e-NB. The term “base station” will be used in the following and is intended to include the use of any one of these access nodes or any other suitable access node.

The base station 4 has a cell 16 associated therewith. In the cell, there is provided three relay nodes, 10a, 10b and 10c. This is by way of example only. In practice, there may be more or less than three relay nodes.

The relay nodes can be used close to the edge of a cell to extend coverage, provided in a traffic hotspot, and/or provided in a location where there is an issue of shadowing from, for example, buildings. Each of the relay nodes 10a-c has a respective coverage area 18, 20 and 22 associated therewith. The coverage area is generally smaller than that of the cell. However, in some scenarios, the coverage area associated with the relay may be of a similar size to a cell or even larger than the cell. User equipment in the cell 16 is able to communicate directly with the base station 4 or with the base station 4 via a respective relay node 10 depending on the location of the user equipment in the cell. Generally but not necessarily, if user equipment is in the coverage area associated with the relay node, the user equipment will communicate with that relay node.

The user equipment or any other suitable communication device can be used for accessing various services and/or applications provided by a communications system. In wireless or mobile communications systems, the access is provided by an access interface between the mobile communication devices and an appropriate wireless access system. The user equipment can typically access wirelessly a communication system via at least one base station. The communication devices can access the communication system based on various access techniques, such as code division multiple access (CDMA), or wideband CDMA (WCDMA), the latter technique being used by communication systems based on the third generation partnership project. Other examples include time division multiple access (TDMA), frequency division multiple access (FDMA), space division multiple access (SDMA) and so on. Various hybrids of one or more of these techniques can also be used. In a wireless system, a network entity such as the base station or relay node provides an access node for communication devices.

A (type 1) relay node has been proposed which is an in-band relay node having a separate physical cell ID (Identity), support of HARQ (Hybrid Automatic Repeat Request) feedback and backward compatibility to release 8 (REL8) UE.

A (type 2) relay node, a so-called transparent relay node has been suggested.

Of course alternative or additionally types of relay node may be used with embodiments of the invention. Different types of relay node may have differing amounts of functionality associated therewith.

In the RAN2 #65 bis meeting, (this is part of 3GPP) RAN2 agreed with the definition for the nodes and the interfaces as shown in FIG. 2. A wireless interface 14 is provided between the user equipment 6 and the relay node 10. This interface is called the Uu interface. This link is an access link. For those embodiments where backward compatibility is desirable, for example where compliance with a particular version of 3GPP standards TR36.319 is required, the Uu interface would be consistent with the release 8 interface as defined in LTE. The wireless interface 12 between the relay node 10 and the donor e-NB 4 (i.e. base station) is the Un interface. This link is considered as the backhaul link.

A paging procedure is used in a number of different cellular communication networks. The paging procedure is used in order to page user equipment, when they are in the idle mode, to inform user equipment about system information changing, to provide any ETWS notification or any other suitable paging information. The paging procedure is generally initiated by sending, as shown in FIG. 1a, a paging message from an MME 2 (mobility management entity) to the base station 4. The paging message generally has one or more of the following information: message type; user equipment identity index value (IMSI International Mobile Subscriber Identity mod L); UE paging ID: IMSI; S-TMSI (Temporary Mobile Subscriber Identity); CN domain; paging DRX (Discontinuous Reception); and list of TAIs (Tracking Area Identity).

The paging message is sent from the MME 2 to the base station 4 via an interface which may or may not be wireless.

Reference is made to FIG. 1b which shows a paging message being sent from the EUTRAN (Evolved Universal Mobile Telecommunications System Terrestrial Radio Access Network) 8 to the user equipment 6, via a wireless interface. In practice, the EUTRAN node sending the paging message will be the relay node or the base station.

Generally, on reception of the paging message, in a system where there are no relay nodes, a base station would perform paging of the user equipment in cells which belong to tracking areas (TAs) as indicated in the list of TAIs information elements. In case that the paging DRX information element is present, the base station calculates the paging occasions as specified for example by 3GPP TR 36.304. The paging message sent from the base station to the user equipment comprises the following: paging record list; one paging record includes the user equipment identity—IMSI, S-TMSI and the domain which indicates if the paging indicates whether Paging is originated from the CS or PS (circuit switched or packet switched domain).

The paging message over the S1 interface between the MME and the base station is referred to as S1-PAGING whilst the paging message sent from the base station to the user equipment will be referred to as RRC-PAGING.

In a relaying system, the paging message will need to go through both the base station 4 and the relaying node 10 after it has been initiated by the MME 4. The S1 interface is provided between the MME and the base station.

In one embodiment of the present invention, the paging channel over the Un interface is per tracking area, that is for the relay nodes connected to one base station, the relay nodes within the same tracking area share one paging channel. Alternatively, more than one paging channel may be associated with the tracking area.

When a relay node is accessing the base station, one or more paging channels may be configured by the base station. The paging channel is a dedicated radio resource and may comprise one or more MBSFN (Multimedia Broadcast Multicast Service Single Frequency Network) subframe over which the relay node needs to check for paging messages. In an embodiment where MBSFN subframes are used for the transmission from the base station to the relay node, the RN-PCCH-configuration IE (relay node-paging channel-configuration information element) is as shown below:

| | |
|---|---|
| RN-PCCH-Config ::= | SEQUENCE { |

| radioframeAllocationPeriod | |
|---|---|
| radioframeAllocationOffset | |
| subframeAllocation | CHOICE { |

| | |
|---|---|
| oneFrame | BIT STRING (S1ZE(6)), |
| fourFrames | BIT STRING (SIZE(24)) |

}

Details of the fields of the IE are shown in Table 1.

TABLE 1
radioFrameAllocationPeriod, radioFrameAllocationOffset
Radio-frames that contain paging subframes over Un interface occur when equation
SFN mod radioFrameAllocationPeriod = radioFrameAllocationOffset is satisfied.
subframeAllocation
Defines the subframes that are allocated for paging to RNs within the radio frame
allocation period defined by the radioFrameAllocationPeriod and the
radioFrameAllocation Offset.
oneFrame
“1” denotes that the corresponding subframe is allocated for paging to RNs. The
following mapping applies:
FDD: The first/leftmost bit defines the allocation for subframe #1, the second bit for #2,
third bit for #3, fourth bit for #6, fifth bit for #7, sixth bit for #8.
TDD: The first/leftmost bit defines the allocation for subframe #3, the second bit for #4,
third bit for #7, fourth bit for #8, fifth bit for #9. Uplink subframes are not allocated. The
last bit is not used.
fourFrames
A bit-map indicating paging subframe allocation in four consecutive radio frames, “1”
denotes that the corresponding subframe is allocated for paging to RNs. The bitmap is
interpreted as follows:
FDD: Starting from the first radioframe and from the first/leftmost bit in the bitmap, the
allocation applies to subframes #1, #2, #3, #6, #7, and #8 in the sequence of the four
radio-frames.
TDD: Starting from the first radioframe and from the first/leftmost bit in the bitmap, the
allocation applies to subframes #3, #4, #7, #8, and #9 in the sequence of the four radio-
frames. The last four bits are not used. Uplink subframes are not allocated.

The paging configuration may be included in system information from the base station to the relay nodes or can be sent to the relay node when the relay node is establishing a connection with the base station. For example, the relay node may send a connection request to the base station. In response to that request, the base station would provide connection configuration information comprising the paging channel configuration information, as shown in table 1 above. It should be appreciated that the above channel configuration information is by way of example and only some of the above information may be used. Alternatively or additionally different paging information may be used in alternative embodiments of the invention.

In some embodiments of the present invention, more than one relay node may be associated with the base station. Each relay node is associated with a tracking area which is identified by a tracking area identity (TAI).

In some embodiments of the invention, a base station may not be able to serve a relay node and user equipment at the same time where, for example the radio resources for the backhaul and access links are in TDM (time division multiplexing). In those embodiments, the more paging channels which are allocated to relay nodes within one radio frame, the less radio resource would be available for the transmission between the base station and its associated user equipment. The relay nodes which have the same TAI may receive the same paging message. Embodiments of the present invention, as described will use the same PCCH configuration for the relay nodes within the same tracking area.

Referring to FIG. 3, assuming that the first relay node 10a and the second relay node 10b are associated with the same TA, subframe number 1 is configured so that the first and second relay nodes monitor that same subframe for possible paging messages. In contrast, the third relay node 10c has a different TAI and accordingly is arranged to monitor a different subframe, for example subframe 6 in the example shown.

It should be appreciated that in some embodiments of the present invention, different TAIs may be associated with the same PCCH configuration. In those embodiments, the relay nodes in the different TAIs may be arranged to monitor the same subframe.

Reference is now made to FIG. 4 which shows a first embodiment of the invention. In this embodiment, the base station 4 transparently delivers the S1-PAGING message to the relay node 10. In particular, the MME 2 sends the S1-PAGING message to the base station 4. The base station 4 transparently forwards the S1-PAGING message to the relay node 10. In other words, the base station makes no changes to the paging message. In an alternative embodiment of the present invention, if there is a direct connection between the MME 2 and the relay node 10, the S1-PAGING message can be delivered directly to the relay node 10, bypassing the base station 4.

This paging message received by the relay node 10 is as previously described. The relay node is configured to process the received S1-PAGING message to generate the RRC paging message, discussed previously. This RRC-PAGING message is then transmitted by the relay node 10 to the user equipment. This approach may be used in those embodiments where the relay node is able to decode the S1-PAGING message, in the same way as the base station. This may be used in embodiments where the S1AP (Application Protocol) is supported by the relay node. The S1 interface is the interface between MME and eNB. There is a protocol specifying the messages over this interface, e.g. 3GPP specification 36.413. It should be appreciated that this is by way of example only and some embodiments of the present invention can be used in conjunction with any other suitable protocol.

A “type 1” relay node where S1-AP is terminated at RN may, for example be used with the embodiments shown in FIG. 4. However, alternative types of relays additionally or alternatively be used.

Reference is made to FIG. 5 which shows a second embodiment of the invention. Some of the information in the S1-PAGING message is not required by the relay nodes to map the S1-PAGING message to the RRC-PAGING message to be sent to the user equipment. For example, the list of TAIs information element is not required. Accordingly, in the embodiment shown in FIG. 5, the S1 paging message is sent as usual from the MME 2 to the base station 4. The base station 4 is arranged to remove from the S1-PAGING message unnecessary information elements which are not required by the relay. For example, the list of TAIs may be omitted. The so-called Optimised S1-PAGING message may then be sent by the base station 4 to the relay node 10. This message may comprise the following information: message type; UE Identity Index Value-IMSI mod L; UE paging ID-IMSI, S-TMSI; and paging DRX.

The relay node, on receipt of the S1-PAGING message, modified by the base station, will map that received message onto the RRC-PAGING message. The relay node then transmits the RRC-PAGING message to the user equipment. This approach may be used in a so-called “type 1” relay which is able to recognise the Optimised S1-PAGING message and provide the RRC-PAGING message there from. Alternative relays may be alternatively or additionally used. In this embodiment, the resource consumption between the base station and the relay node can be reduced. This is a wireless interface and as such provides advantages in some embodiments of the invention.

Reference is made to FIG. 6 which shows a third embodiment of the invention. The MME 2 sends the S1-PAGING message to the base station 4. The base station 4 generates a Un-PAGING message. This Un-PAGING message is sent from the base station to the relay node. The Un-PAGING message comprises one or more paging records. In particular, the base station provides RRC-PAGING messages to the relay node for each of the user equipment to which a respective paging message is required. The same RRC-PAGING message may be intended for a single UE or for a plurality of UE. There may be a one to one association between a paging record and a UE.

The base station 4 is arranged to send the RRC-PAGING messages to the relay node. The relay node maps the received RRC-PAGING messages to the required paging occasions. The mapping may be based on preconfigured mapping patterns.

In this third embodiment, the relay node is not required to support the RRC functionality to constitute the RRC-PAGING messages. Accordingly, this third option can be used with a so-called Layer-2 relay where the relay node does not have any paging-related RRC functionality. This third option may alternatively or additionally be used with type 1 relay where the S1-AP is terminated at DeNB. In the third embodiment, the RRC paging functionality relating to paging may be removed to the base station. The relay node only needs to forward the received RRC-PAGING message without requiring any check or modification of the content. This embodiment may have a smaller overhead since the lower layer message is delivered over the backhaul link.

The base station may be arranged to configure a PO (paging occasion) mapping pattern or mapping information which is sent to the relay node via system information or during the setting up of the connection between the relay node and the base station. For example, the PO mapping pattern may be provided in response to a connection request from the relay node. That PO mapping pattern is provided by the base station 4 to the relay node 10. The PO mapping pattern provides timing relationship information between the paging occasion over the Un interface and the paging occasion over the Uu interface which may be included in the RN-PCCH-configuration IE. The Un-PAGING message comprises one or more RRC-PAGING messages where each message includes a paging record list comprising one or more paging records derived from the S1-PAGING message. The base station processes the received S1 paging message to provide the Un-PAGING message. The relay node then forwards the respective RRC-PAGING message received from the base station in the Un-PAGING message at the respective paging occasion based on the mapping pattern. It is not required that the relay node modify any of the RRC paging messages, in this embodiment.

The paging occasion mapping may be used with any of the embodiments previously described.

It is possible to have a one-to-one mapping between the Un and Uu interfaces as shown in FIG. 7a or a one-to-N mapping as shown in FIG. 7b. A one-to-one mapping means one Un paging occasion from the base station to the relay node will be matched to one paging occasion on the Uu interface. With reference to FIG. 7a, the base station 4 receives the S1-PAGING message from the MME over subframe 1 and 6 which are considered as the paging occasions for the Un interface. In this example, the paging occasions for the Uu interface are subframe 4 and 9. In the examples shown in FIG. 7a, there is one-to-one mapping. This means that paging occasion in respect of subframe 1 for the Un interface maps to the paging occasion in subframe 4 for the Uu interface. Likewise, subframe 6 is used in the connection between the base station and the relay node. This subframe maps to subframe 9 for the connection between the relay node and the user equipment.

Reference is made to FIG. 7b which shows 1-N mapping. In this example, N is 2, however, it should be appreciated that N can have any suitable value. This means that one paging occasion on the Un interface between the base station and the relay node will be mapped to N paging occasions in the Uu interface between the relay node and the user equipment. For example, in the connection between the base station and the relay node, the paging occasions are defined by subframes 1 and 6. Subframe 1 paging occasion maps to paging occasions 4 and 5 in the connection between the relay node 10 and the user equipment. Likewise paging occasion in subframe 6 in the connection between the node B and the relay node maps to paging occasions in subframes 9 and 0 in the connection between the relay node and user equipment.

In this regard, the table below shows the mapping between the subframes in the Un interface to the subframes in the Uu interface for the example shown in FIG. 7a.

| Un-PO | Uu-PO |
|---|---|
| (subframe #) | (Subframe #) |
| 100000 | 0100 |
| 000100 | 0001 |

Similarly, the table below shows the mapping between the subframes in the Un interface to the paging occasions in the subframes on the Uu interlace for the example shown in FIG. 7b. In the table below, each digit shows whether there is paging message over the corresponding subframe. In one example, over the Un interface, 6 subframes may be available for transmission between the base station and the relay node, therefore 6 digits are used. In this example, over the Uu interface, up to 4 paging occasions are available within one frame, so 4 digits are used. It should be appreciated that in other embodiments the number of paging occasions available in a frame differ from these example values.

| Un-PO | Uu-PO |
|---|---|
| (subframe #) | (Subframe #) |
| 100000 | 0100 |
| | 0010 |
| 000100 | 0001 |
| | 1000 |

One possible paging occasion mapping pattern information element is shown in the table below.

| | |
|---|---|
| PO-MAPPING-PATTERN-List ::= | SEQUENCE (SIZE |

(1: number of Un-PO )) OF PO-MAPPING-PATTERN

| | |
|---|---|
| PO-MAPPING-PATTERN ::= | CHOICE { |

| | |
|---|---|
| OnetoOneMapping | SEQUENCE{ |

| | |
|---|---|
| Un-PagingOccasion | BIT STRING (SIZE (6)) |
| Uu-PagingOccasion | BIT STRING (SIZE (4)) |

| } | |
|---|---|
| OnetoMultipleMapping | SEQUENCE { |

| | |
|---|---|
| Un-PagingOccasion | BIT STRING (SIZE (6)) |

| | |
|---|---|
| Uu-PagingOccasionList | SEQUENCE { |

| | |
|---|---|
| Uu-PagingOccasion | BIT STRING (SIZE (4)) |

}

}

}

The table below explains the fields in the above information element.

OnetoOneMapping
One paging occasion over Un interface is mapped to one paging occasion over Uu interface.
OnetoMultipleMapping
One paging occasion over Un interface is mapped to multiple paging occasions over Uu Interface. This could be
possible given better link status between DeNB and RN.
Un-PagingOccasion
“1” denotes that the corresponding subframe is allocated for paging from DeNB to RNs. The following mapping
applies:
FDD: The first/leftmost bit defines the allocation for subframe #1, the second bit for #2, third bit for #3, fourth bit for
#6, fifth bit for #7, sixth bit for #8.
TDD: The first/leftmost bit defines the allocation for subframe #3, the second bit for #4, third bit for #7, fourth bit for #8,
fifth bit for #9. Uplink subframes are not allocated. The last bit is not used.
Uu-PagingOccasion
“1” denotes that the corresponding subframe is allocated for paging from RNs to UEs. The following mapping applies:
FDD: The first/leftmost bit defines the allocation for subframe #0, the second bit for #4, third bit for #5, fourth bit for #9
TDD: The first/leftmost bit defines the allocation for subframe #0, the second bit for #1, third bit for #5, fourth bit for #6
For OnetoMultipleMapping, a list of
Uu-PagingOccasionList
For OnetoMultipleMapping, a list of Uu-PagingOccasion is included. The ith item in the list shows the Uu-
PagingOccasion to which the ith RRC-PAGING message within the Un-PAGING message is mapped.

The paging occasion mapping pattern consists of a list of paging occasion mapping patterns (PO-MAPPING-PATTERN) for each Un interface paging occasion which may be preconfigured by the relay node-PCCH-configuration. This defines one-to-one mapping and/or one-to-N mapping.

Embodiments of the present invention provide various different methods for delivery paging messages over the Un interface.

Some embodiments of the present invention provide different formats for paging messages over the Un interface. These different formats may depend on the available relay node functionality. The arrangement shown in FIG. 4 has the advantage that there is very little potential impact to the interface when applying the current specification for the eNB to a relay node. The embodiments described in relation to FIG. 5 may provide some overhead reduction in respect of the wireless connection between the base station and the relay node. The embodiments described in relation to FIG. 6 may have the advantage that the functionality at the relay node may be simplified since the need to modify the received paging message may be avoided. The overhead may be minimised by using lower layer paging messages over the Un interface.

Reference is made to FIG. 8 which shows a block diagram of a node embodying the present invention. This node may be the base station or the relay node. In particular, the data processing part 300 of the node is shown. This data processing part is connected to a transmitter receiver part 312 which upconverts data to be sent on a radio frequency and which downconverts data which is received to the baseband. The transmitter/receiver part may be connected to an antenna arrangement 313 which is arranged to transmit and receive radio frequency signals.

The node also comprises a memory 302 which is connected to the data processing part and which is used by various functions of the data processing part 300.

The processing part 300 may comprise a message processing part 306. The function of this part 306 will depend on which embodiment the arrangement of FIG. 8 is being used and whether or not that node is a base station or a relay node. For example, the message processing part 306 may be arranged to remove information elements from the paging message as discussed above. Alternatively, the message processing part 306 may be arranged to process the received paging message to generate an RRC-PAGING message and/or a paging record list.

The processing part 300 may be implemented by one or more integrated circuits. The memory may be part of one or more of the integrated circuits or may be separately provided.

A non-limiting example of mobile architectures where the herein described principles may be applied is known as the Evolved Universal Terrestrial Radio Access Network (E-UTRAN). The eNBs may provide E-UTRAN features such as user plane Radio Link Control/Medium Access Control/Physical layer protocol (RLC/MAC/PHY) and control plane Radio Resource Control (RRC) protocol terminations towards the user devices.

It should be appreciated that in those embodiments where there is a wired connection between the base station and the relay node, the communication between the base station and the relay node will be via the wired connection.

At least some of the processing of processing part may be carried out by one or more processors in conjunction with one or more memories.

The Processing part may be provided by an integrated circuit or a chip set.

At least some of the functions of processing part may alternatively or additionally be provided by a processing part of a controller of the access points, for example a radio network controller or the like. For example, the determining of the loading and the scheduling may be carried out by such a controller.

The required data processing apparatus and functions of a relay node and a base station apparatus as well as an appropriate communication device may be provided by means of one or more data processors. The above described functions may be provided by separate processors or by an integrated processor. The data processing may be distributed across several data processing modules. A data processor may be provided by means of, for example, at least one chip. Appropriate memory capacity can also be provided in the relevant nodes. An appropriately adapted computer program code product or products may be used for implementing the embodiments, when loaded on an appropriate data processing apparatus, for example in a processor apparatus associated with the base station, processing apparatus associated with relay node and/or a data processing apparatus associated with a UE. The program code product for providing the operation may be stored on, provided and embodied by means of an appropriate carrier medium. An appropriate computer program can be embodied on a computer readable record medium. A possibility is to download the program code product via a data network.

It is noted that whilst embodiments have been described in relation to LTE, similar principles can be applied to any other communication system where relaying is employed. Therefore, although certain embodiments were described above by way of example with reference to certain exemplifying architectures for wireless networks, technologies and standards, embodiments may be applied to any other suitable forms of communication systems than those illustrated and described herein.

It is also noted herein that while the above describes exemplifying embodiments of the invention, there are several variations and modifications which may be made to the disclosed solution without departing from the scope of the present invention.

1. A node comprising:
means for receiving a paging message; and
transmitting means for transmitting the paging message to at least one relay node.

2. A node as claimed in claim 1, wherein said transmitting means is configured to transmit said paging message without modification.

3. Apparatus for use in a base station comprising:
processing means for modifying a received paging message; and
means for causing transmission of the modified paging message to a relay node.

4. Apparatus as claimed in claim 3, wherein said processing means is configured to modify the received paging message by removing information therefrom.

5. Apparatus as claimed in claim 4, wherein said processing means is configured to remove area information.

6. Apparatus as claimed in claim 5, wherein said processing means is configured to remove tracking area information.

7. Apparatus for use in a base station comprising:
processing means for processing a received paging message to generate at least one user equipment paging message in a format suitable for transmission to a user equipment; and
means for causing transmission of said at least one user equipment paging message to a relay node.

8. Apparatus as claimed in claim 7, wherein said processor means is configured to determine a paging mapping pattern.

9. Apparatus or node as claimed in claim 1, wherein a same paging message is transmitted to a plurality of relay nodes.

10. Apparatus or node as claimed in claim 9, wherein said same paging message is transmitted to a plurality of relay nodes in a common paging occasion.

11. Apparatus or node as claimed in claim 9, wherein the same paging message is transmitted to a plurality of relay nodes having common identity information.

12. Apparatus or node as claimed in claim 11, wherein said common identity information comprises tracking area identity.

13. Apparatus for use in a relay node comprising:
means for processing a received paging message to provide a modified paging message; and
means for causing transmission of the modified paging message to the user equipment.

14. A relay node comprising:
receiving means for receiving at least one paging message, said at least one paging message for transmission to a user equipment; and
means for transmitting said at least one paging message without modification to respective user equipment.

15. A relay node or apparatus as claimed in claim 13, wherein said paging message for transmission to the user equipment is a radio resource control paging message.

16. A relay node or apparatus as claimed in claim 13, wherein said paging message for transmission to the user equipment comprises at least one paging record.

17. A relay node or apparatus as claimed in claim 16, wherein said paging record comprises at least one of the following:
user identity information; and
cellular network domain information.

18. A relay node or apparatus as claimed in claim 13, comprising mapping means for mapping one paging occasion in a link between said relay node and a node to one paging occasion in a link between the relay node and user equipment.

19. A relay node or apparatus as claimed in claim 13, comprising mapping means for mapping one paging occasion in a link between the relay node and a node to N paging occasions in a link between the relay node and user equipment, N being greater than or equal to 2.

20. Apparatus or relay node as claimed in claim 13, wherein said paging message comprises one or more of the following information:
message type information;
user equipment identity index value information;
user equipment paging identity;
paging DRX information; and
area information.

21. A method comprising:
receiving a paging message; and
transmitting the paging message to at least one relay node.

22. A method as claimed in claim 21, comprising transmitting said paging message without modification.

23. A method comprising:
modifying a received paging message; and
causing transmission of the modified paging message to a relay node.

24. A method as claimed in claim 23, comprising modifying the received paging message by removing information therefrom.

25. A method as claimed in claim 24, comprising removing area information.

26. A method as claimed in claim 25, comprising removing tracking area information.

27. A method comprising:
processing a received paging message to generate at least one user equipment paging message for transmission to a user equipment; and
causing transmission of said at least one user equipment paging message to a relay node.

28. A method as claimed in claim 27, comprising determining a paging mapping pattern.

29. A method as claimed in claim 21, comprising sending a same paging message to a plurality of relay nodes.

30. A method as claimed in claim 29, comprising sending said same paging message to a plurality of relay nodes in a common paging occasion.

31. A method as claimed in claim 29, comprising transmitting the same paging message to a plurality of relay nodes having common identity information.

32. A method as claimed in claim 31, wherein said common identity information comprises tracking area information.

33. A method comprising;
processing a received paging message to provide a modified paging message; and
causing transmission of the modified paging message to the user equipment.

34. A method comprising:
receiving means for receiving at least one paging message, said at least one paging message in a format suitable for transmission to a user equipment; and
means for transmitting said at least one paging message without modification to respective user equipment.

35. A method as claimed in claim 33, wherein said paging message for transmission to the user equipment is a radio resource control paging message.

36. A method as claimed in claim 33, wherein said paging message for transmission to the user equipment comprises at least one paging record.

37. A method as claimed in claim 36, wherein said paging record comprises at least one of the following:
user identity information; and
cellular network domain information.

38. A method as claimed in claim 33, comprising mapping one paging occasion in a link between said relay node and a node to one paging occasion in a link between the relay node and user equipment.

39. A method as claimed in claim 33, comprising mapping one paging occasion in a link between the relay node and a node to N paging occasions in a link between the relay node and user equipment, N being greater than or equal to 2.

40. A computer program or computer program medium comprising computer code which when executed on a processor is configured to perform the method of claim 21 when executed on a processor.

41. Apparatus comprising:
at least one processor and at least one memory including program code, the at least one memory and the program code configured to, with the at least one processor cause the apparatus at least to receive, a paging message; and
transmit the paging message to at least one relay node.

42. Apparatus comprising:
at least one processor and at least one memory including program code, the at least one memory and the program code configured to, with the at least one processor cause the apparatus at least to modify a received paging message; and
cause transmission of a modified paging message to a relay node.

43. Apparatus comprising:
at least one processor and at least one memory including program code, the at least, one memory and the program code configured to, with the at least one processor cause the apparatus at least to process a received paging message to generate at least one user equipment paging message in a format suitable for transmission to a user equipment; and
cause transmission of said at least one user equipment paging message to a relay node.

44. Apparatus comprising:
at least one processor and at least one memory including program code, the at least one memory and the program code configured to, with the at least one processor cause the apparatus at least to process a received paging message to provide a modified paging message; and
cause transmission of the modified paging message to the user equipment.
